(19) United States
(12) Patent Application Publication
(10) Pub. No.: US 2002/0192406 A1
(43) Pub. Date: Dec. 19, 2002

(54) Methods for wrapping master rolls of paper manufactured in paper-maker plants

(76) Inventors: Michel Labbe, Victoriaville (CA); Martin Parenteau, Kingsey Falls (CA); Hughes Prud'homme, St.-Thomas (CA)

Correspondence Address: Kevin R. Erdman, Baker & Daniels, Suite 2700, 300 N. Meridian Street, Indianapolis, IN, 46204, US

(21) Appl. No.: 10/122,155

(22) Filed: Apr. 12, 2002

Related U.S. Application Data
(60) Provisional application No. 60/283,154, filed on Apr. 12, 2001.

(51) Int. Cl. B32B 1/02; B65B 11/56

(52) U.S. Cl. 428/34.2; 53/465; 53/211

(57) ABSTRACT

The present invention relates to repulpable wrappers comprising water-activatable adhesive(s). The present invention is also concerned with methods for wrapping a master roll of paper manufactured in a paper-maker plant. The present invention is also concerned with a master roll of paper wrapped with a wrapper having a water-activated adhesive. The wrappers of the invention are fully recyclable and fully repulpable. They are also less sensitive to blocking than regular commonly used wrappers. The methods for wrapping master rolls of paper according to the invention are more effective and much more environmentally friendly than the methods actually used in the industry.

### RELATED APPLICATION

This application claims priority of U.S. Provisional Application No. 60/283,154 filed Apr. 12, 2001, the disclosure of which is incorporated by reference herein in its entirety.

### BACKGROUND OF THE INVENTION

A. Field of the Invention

The present invention relates to repulpable wrappers comprising water-activatable adhesive(s). More particularly, the present invention is concerned with methods for wrapping, with the repulpable wrappers of the invention, a master roll of paper manufactured in a paper-maker plant. The present invention is also concerned with master rolls of paper wrapped with such repulpable wrappers.

B. Brief Description of the Prior Art

It is a common practice to wrap many objects to preserve these objects from moisture, dirt, grease, gas, light and other potential damages.

For instance, master rolls of paper manufactured in paper-maker plants are generally wrapped in a paperboard wrapper in order to preserve their quality as they are shipped from the plant to the customer.

The most common method for master roll wrapping consists of unwinding and gluing at least one coil of a wrapper, typically a Kraft sheet, around the master roll (see for instance U.S. Pat. No 4,508,773). The glue is generally used to bond a free end of wrapper to an outside peripheral surface of the master roll. A second glue application is done at the end of a first wrap to bind together overlapping surfaces of wrapper. The glues that are presently used in the industry are hot melt adhesives (i.e. solid or semi-solid adhesives that are melted and which adhere once cooled), water-based glues (i.e. glues that are composed of water and which adhere once dried) or water dispersible adhesives (i.e. adhesives that are water soluble). Examples of different types of adhesives and glues can be found in U.S. Pat. Nos. 3,951,890; 3,994,396; 5,989,724; 6,007,910; and 6,034,168.

Another method of wrapping master rolls consists of using wrappers coated with polyethylene. When submitted to a heating device such as an infrared heater, the polyethylene of the wrapper melts, thereby allowing the wrapper to adhere to the master roll as well as to overlapping surfaces of wrapper. The VALMET TOP PACK™ wrapping concept is an example of such an application.

Other known systems use a combination of the two previously mentioned technologies: 1) a gluing system to bind a free end of wrapper to the outside peripheral surface of the master roll; and 2) a heat sealable system to bind together overlapping surfaces of wrapper.

A first disadvantage of these known wrapping methods, and more particularly the ones using water-based glues or water dispersible adhesives is that air contamination occurs near the wrapping line because of the spraying system that is typically used to apply the glues. Fine glue droplets are vaporized through the ambient air, which may cause health problems to workers and contamination of the wrapping line equipment.

Furthermore, the glues or adhesives that are used in all these known systems have a negative effect in the recycling of wrapper waste. Therefore, the presence of these glues is a major obstacle to improve the rate of recycling. Indeed, it is known that to be repulpable, the wrappers which contain these glues need to be mechanically treated in a pulper device to obtain a wood fiber slurry. The slurry is then processed in a floatation cell for a bubble treatment which achieves the removal of the glues from the slurry. The problem is that not all glues are removed by this process, since only large size glue particles are removed. Some residual glue passes through the repulpation process and remains in the pulp slurry. The lafter situation causes many maintenance problems because the glue sticks and accumulates onto the surface of felts and of wires of paper machines.

There is therefore a need for wrappers and for better methods of wrapping master roll of paper that overcome the problems associated to the wrappers known in the art.

There is more particularly a need for wrapping methods which do not involve the spraying of glue.

There is also a long felt need for a wrapper that is fully recyclable and fully repulpable. There is also a need for wrapped master rolls of paper wrapped with such a wrapper.

The present invention fulfils these needs and also other needs which will be apparent to those skilled in the art upon reading the following specification.

### SUMMARY OF THE INVENTION

According to an aspect, the present invention relates to a wrapper that is recyclable and environmentally friendly.

According to another aspect, the present invention relates to a wrapper that may be easily repulped.

In accordance with the above-mentioned aspects, the invention provides a recyclable and repulpable wrapper which comprises a sheet of a cellulosic material having an area coated with a water-activatable adhesive. According to a preferred embodiment, the water-activatable adhesive is coated directly onto the cellulosic sheet. According to another embodiment, the wrapper comprises a functional barrier, such as a layer of a latex-based product, that is applied between the cellulosic sheet and the adhesive.

According to another aspect, the present invention relates to a multilayer wrapper which comprises:

a first sheet of a cellulosic material having an upper face and a lower face, the upper face having an area coated with a layer of a water-activatable adhesive;

a second sheet of a cellulosic material; and

a functional barrier laminated between the second sheet and the lower face of the first sheet.

According to a further aspect, the present invention relates to a method for manufacturing a cellulosic wrapper, comprising the steps of providing a sheet of a cellulosic material; and applying a water-activatable adhesive onto an area of the sheet.

According to another aspect, the present invention relates to a method for manufacturing a multilayer cellulosic wrapper, comprising the steps of:

providing a first sheet of a cellulosic material having an upper face and a lower face, the upper face preferably comprising, an area coated with a layer of a water-activatable adhesive;

providing a second sheet of a cellulosic material;

bounding the lower face of the first sheet to the second sheet with a suitable functional barrier.

In another aspect, the present invention relates to a method for manufacturing a cellulosic container or box. According to a preferred embodiment, the method comprises the steps of:

providing a sheet of cellulosic wrapper (single or multilayer) as defined hereinabove;

folding said sheet for forming a container; and

applying an aqueous solution to selected portions of the container for activating the adhesive(s) of the cellulosic sheet, thereby sticking together selected areas of the folded sheet and solidifying the container.

According to another very important aspect that will be described in details hereinafter, the present invention relates to methods for wrapping a master roll of paper. According to a first embodiment, the method comprises the steps of:

providing a wrapper comprising a sheet of a cellulosic material having a first face opposite to a second face, the first face having an area coated with a water-activatable adhesive;

wrapping the master roll of paper with a length of wrapper sufficient to allow the coated area of the first face to face the second face;

activating the water-activatable adhesive coating the area of the first face; and

applying on the area activated a pressure sufficient to bound together the first face of the wrapper to its second face.

According to a more preferred embodiment, the method for wrapping a master roll of paper comprises the steps of:

a) providing a roll of wrapper having a free end, the wrapper comprising a sheet of a cellulosic material having a first face opposite to a second face, the first face being coated with a water-activatable adhesive;

b) spraying the free end of the wrapper, on the first face thereof, with an aqueous solution for activating the adhesive therein;

c) bounding the free end of the wrapper to an outer peripheral portion of the master roll;

d) wrapping the master roll with at least one coil of wrapper such that a length of wrapper overlaps the free end bound at step (c);

e) spraying the length of wrapper, on the first face thereof, with an aqueous solution for activating the adhesive therein; and

f) bounding the length of wrapper sprayed at step (e) to an outer surface of the wrapper previously coiled in step (d) on the master roll.

An advantage of the present invention is that it allows to manufacture wrappers and containers which contain adhesives that are less toxic and easier to recycle/repulp than the glues/plastics which are presently used in the industry.

Providing wrappers and containers that may be easily repulped is an advantage of great economic importance as well as an advantage of environmental importance. The wrappers of the invention are also less sensitive to blocking that regular commonly used wrappers. Also, the methods for wrapping master rolls of paper according to the present invention are more effective and much more environmentally friendly than the methods actually used in the industry.

Other objects and advantages of the present invention will be apparent upon reading the following non-restrictive detailed description of several preferred embodiments.

### BRIEF DESCRIPTION OF THE DRAWINGS

FIG. 1 is an elevated perspective view of an embodiment of the wrapper according to the present invention.

FIG. 2 is an elevated perspective view of another embodiment of the wrapper according to the present invention, the wrapper comprising a functional barrier.

FIG. 3 is an elevated perspective view of another embodiment of the wrapper according to the present invention, the wrapper comprising two cellulosic sheets and a functional barrier.

FIGS. 4A and 4B are an elevated perspective view and a side view, respectively, showing an embodiment of a method for wrapping a master roll of paper, according to the invention.

FIGS. 5A and 5B are an elevated perspective view and a side view, respectively, showing another embodiment of a method for wrapping a master roll of paper, according to the invention.

FIGS. 6A to 6F are side views showing with more details the embodiment of the method shown in FIGS. 4A and 4B, for wrapping a master roll of paper, according to the invention.

### DETAILED DESCRIPTION OF THE INVENTION

According to a first aspect, the present invention is concerned with recyclable and repulpable cellulosic wrappers having an area coated with a water-activatable adhesive.

The wrappers of the invention may be used for various wrapping purposes. Indeed, wrappers with water-activatable adhesive(s), in addition to being repulpable, have the advantage of being non-toxic since they are activatable with an aqueous solution such as water or steam. The wrapper of the invention may thus replace conventional wrapper requiring hot melts, water-based glues, or heat-sealing polyethylene gluing systems.

As it will be described in more details hereinafter, the wrappers of the invention are particularly useful for wrapping rolls of paper, and more particularly large master rolls of paper that are manufactured in paper-maker plants. The wrappers of the invention may also be used as “ream wrap” (i.e. wrappers which typically comprise a sheet of a cellulosic material that is sized and cut according to a desired use) for protecting cut-size business paper. Furthermore, the wrappers of the invention may be used as a cardboard container (e.g. box) since for packaging certain types of goods, cardboard may be preferable. Accordingly, the invention also provides cellulosic cardboard containers which may be used as boxes for dry food and the like (cereal, spaghetti, liquors, etc), as boxes for pharmaceutical products, boxes for commodity applications (tissues, tools, etc), as metallized boxes and others similar types of boxes.

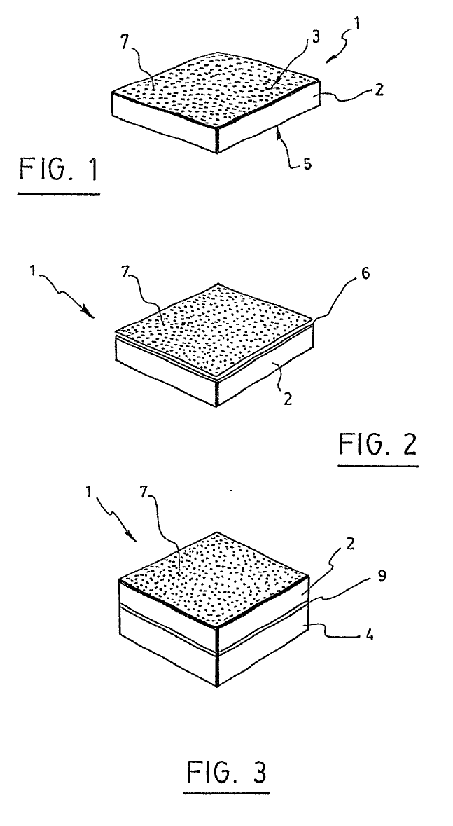

According to a first embodiment that is shown in FIG. 1, the wrapper (1) of the invention comprises a sheet (2) of a cellulosic material having a first face (3) opposite to a second face (5), the first face (3) having an area coated with a water-activatable adhesive (7). The cellulosic material of the sheet is preferably made of virgin wood fibers, recycled wood fibers, cotton fibers and mixtures thereof. The virgin wood fibers are not limited to the type of wood species and they can be produced by conventional pulping processes used in the pulp and paper industry, such as thermo-mechanical pulping (TMP) and chemical pulping. The sheet and the cardboard may comprise recycled wood fibers from the recycled and wasted products or from other cellulosic fiber sources such as cotton in the form of fibers or dust. For wrapping uses, the sheet preferably has a weigh between about 50 g/m² to about 350 g/m² and a thickness between about 100 to 500 μm. For packaging uses, the cardboard preferably has a weigh between about 180 g/m² to about 400 g/m² and a thickness between 200 to 550 μm.

As used herein, the expression “a water-activatable adhesive” encompasses the use of one adhesive or more (i.e. the use of a mixture of adhesives or the separate use of one, two or more different adhesives). The water-activatable adhesive of the invention are those adhesives which are capable of being activated when moisturized or humidified with an aqueous solution and which are capable to develop sufficient stickiness to bond together two sheets of cellulosic material (wrappers) or two sections of a folded cardboard (for box-like containers).

The water-activatable adhesive may be a dextrin-base adhesive such as NACAN™ 682372 (Nancan Ltd, Brampton, ON, CA). The water-activatable adhesive may also be a vinyl/acrylic copolymer emulsion or an acrylic emulsion polymer, preferably with a low glass transitive temperature (Tg) from about −40° C. to about 40° C. Examples of suitable polymeric adhesives include ENVA-LOK™ 68-4074 (from Nancan Ltd), VINAVYL™ 2841, VINAVYL™ 2419, VINAVYL™ 2431 and VINAVYL™ RA-9952 (from Vinavyl Americas, Laval, QC, Canada). A person skilled in the art will however understand that the present invention is not limited solely to these specific adhesives and that other suitable water-activatable adhesives could also be used according to the present invention.

Any coating methods may be used to apply the water-activatable adhesive of the invention. The method will vary depending on various factors such as the type of surface onto which the adhesive is applied, the amount of adhesive that needs to be applied, etc. The water-sensitive adhesive may be applied using conventional coating head technologies such as roll coating, gravure (forward and reverse), squeeze roll coating, air knife, blade, mayer rods coating, spraying, saturators, fountain coating and curtain coating. According to a preferred embodiment, the applied adhesive forms a film that covers 100% of the surface of the sheet or the cardboard. The adhesive may also cover selected areas or non-uniform (e.g. a spray) areas of the sheet or of the cardboard these areas being sufficient to create a good bonding at activation. Preferably, the amount of adhesive that is present on a wrapper is such that the adhesive weighs, once dried, from about 1 g/m² to about 70 g/m². For box-like containers, the preferred amount of adhesive that is applied is such that the adhesive weighs from about 3 g/m² to about 60 g/m². Once it has been applied, the adhesive is generally left to dry and adhere to the sheet/cardboard to constitute the wrapper therewith. Of course, it may also be possible under certain circumstances to use the adhesive while wet.

According to a second embodiment of a wrapper (1) shown in FIG. 2, instead of being applied directly on the sheet of cellulosic material (2), the water-activatable adhesive (7) may also be applied on a sheet (2) or cardboard that has been pre-coated with a functional barrier (6), such as a water barrier, a moisture resistant barrier, a grease resistant barrier or a gas barrier. Examples of preferred functional barriers according to the invention are polyolefines (e.g. polyethylene and polypropylene), polyesters and latexes. These products are preferred because they are resistant to heat, grease, gas and humidity. Latexes are also fully repulpable. Depending on the type of barrier, it may be necessary to proceed to a surface treatment of the barrier to modify its tension surface and increase the adherence of the water-activatable adhesive. For instance, when polyethylene or polypropylene is used, it is recommended to treat its surface with corona discharges to increase the tension surface from 29-31 dynes/cm to a minimum of 45 dynes/cm.

According to a third embodiment of a wrapper (1) shown in FIG. 3, the functional barrier (9) may also be applied between two sheets of cellulose (2, 4), thereby binding together the two sheets (2, 4) into a laminated multilayer structure. In such structure, the water-activatable adhesive (7) would be applied on the external surface of one, and even both sheets (2, 4). Of course, the order into which the functional barrier and the adhesive layer(s) are applied for forming such laminated multilayer structure may vary depending on many variables such as the equipment that is used, a user's needs and the final desired use of the product.

For wrapping and packaging purposes, the adhesive of the sheet and of the cardboard is moisturized for reactivating the stickiness of the adhesive. Preferably, about 1 to 10 g/m², more preferably about 3 to 5 g/m², of aqueous solution should be used for activating the adhesive. Preferably, the aqueous solution consists of water but any other water-based solution (e.g. saline solutions, alcoholic solutions, acidic solutions) could also be used, although less preferable. Any equipment capable of moisturizing the water-activatable adhesive is suitable according to the invention. Commonly used equipment includes steam showers, spray nozzles and roller applicators. Of course, it may also be possible to use the adhesive while wet, thereby rendering unnecessary the moisturizing step. The amount of aqueous solution that is necessary and the equipment to be used will vary according to various factors such as the type of adhesive(s), the amount of adhesive(s), the ambient temperature, the temperature of the solution, the pressure to be applied to bound the adhesive(s), the type of equipment used, etc.

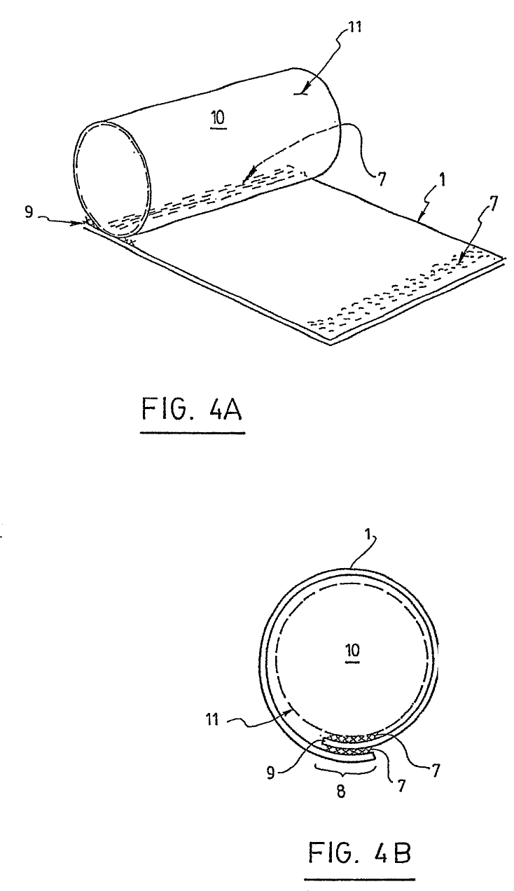

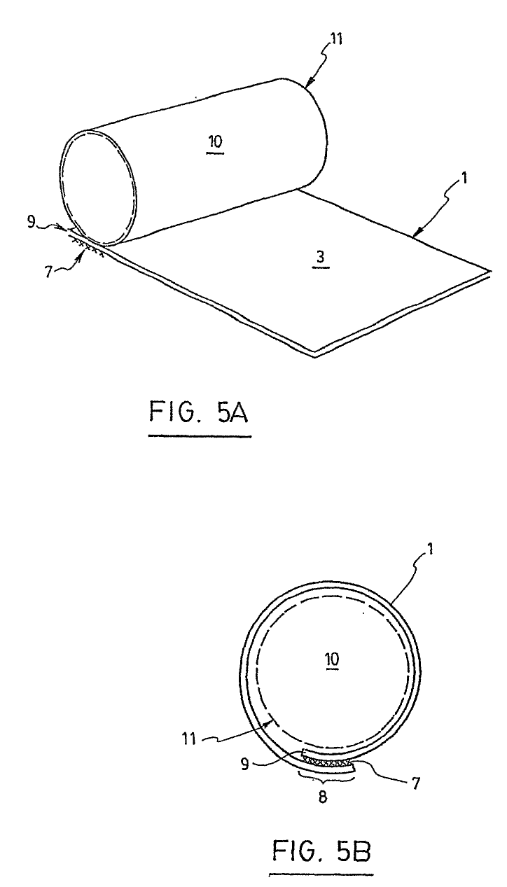

According to another aspect, the present invention is concerned with methods for wrapping a master roll of paper by using a wrapper comprising a sheet of a cellulosic material having an area coated with a water-activated adhesive as the ones defined hereinbefore. FIGS. 4A-4B and 5A-5B, show two different suitable approaches for wrapping a master roll (10).

FIGS. 4A-4B shows a method wherein the wrapper (1) is wrapped around an outer peripheral portion (11) of the master roll (10) with the adhesive (7) of the wrapper (1) facing the outer peripheral portion (11) of the master roll (10) (see FIG. 4A). In this embodiment, a free end (9) of the wrapper (1) is bound to the master roll (10). This can be done by: i) activating the water-activated adhesive (7) of the free end (9), and ii) applying a pressure on the free end (9) to achieve bonding. At least one coil of wrapper (1) is then wrapped around the master roll (10) so that a length of wrapper (8) overlaps the bound free end (7). The water-activatable adhesive (7) of the wrapper is then activated thereby permitting opposite faces of the wrapper (1) to be bound together with the adhesive (7) when a sufficient pressure is applied (see FIG. 4B).

FIGS. 5A-5B shows a method wherein the wrapper (1) is wrapped around an outer peripheral portion (11) of the master roll (10) with the adhesive (7) of the wrapper (1) on a face opposite to a face (3) facing the outer peripheral portion (11) of the master roll (10) (see FIG. 5A). In this less preferred embodiment, a free end (9) of the wrapper (1) is held (manually, or by other means) to the master roll (10) and least one coil of wrapper (1) is wrapped around the master roll (10) so that a length of wrapper (8) overlaps the free end (7) (see FIG. 5B). The water-activatable adhesive (7) of the wrapper is then activated, thereby permitting opposite faces of the wrapper to be bound together with the adhesive (7) when a sufficient pressure is applied.

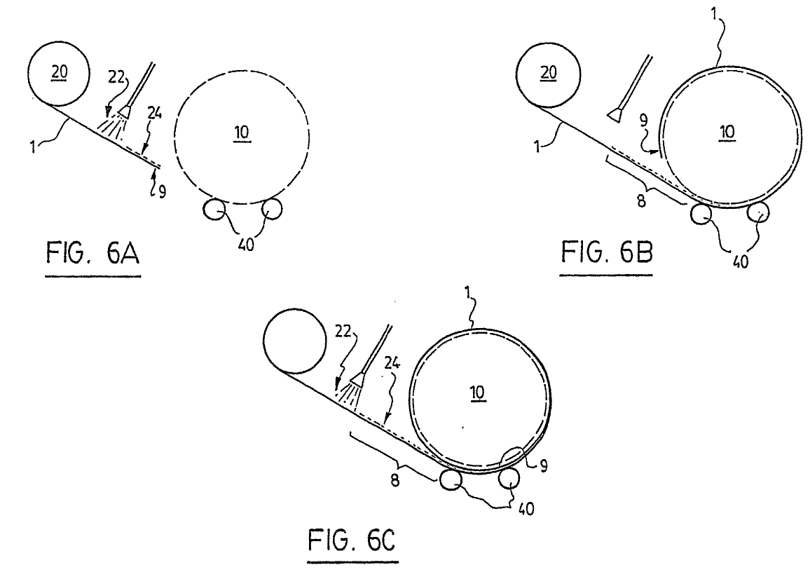

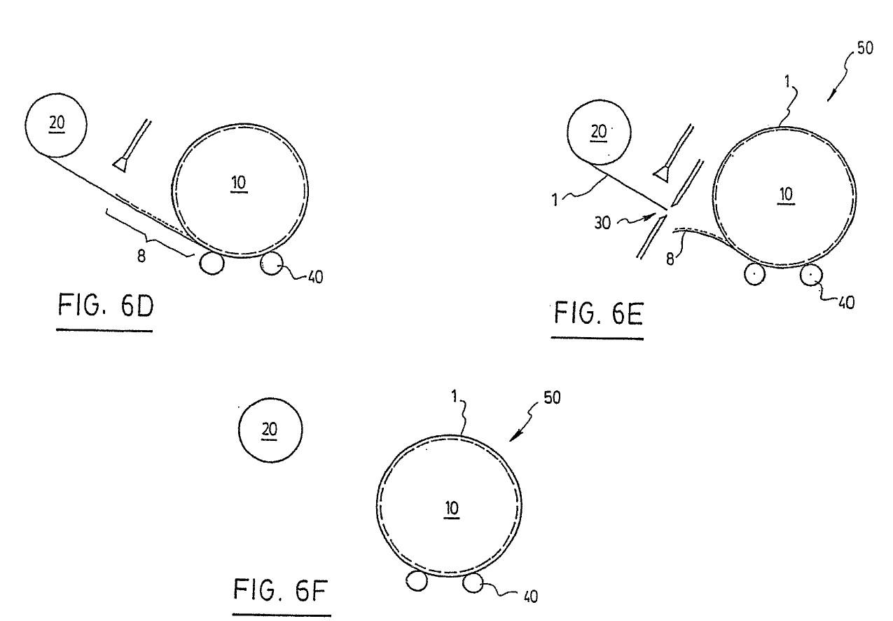

Typically, master roll of papers stands on two rolls (40) while they are wrapped (see FIGS. 6A to 6F). Therefore, preferably the pressure that is required for bounding together the two faces of the wrapper is applied by rolling the master roll on such a roll.

FIGS. 6A to 6F show in more details another, more preferred embodiment, of the method of the invention. According to this embodiment, a roll (20) of wrapper (1) having a free end (9) is provided (FIG. 6A). The wrapper (1) comprises a sheet of a cellulosic material having an upper face entirely coated with a water-activatable adhesive (not shown). The free end (9) of the wrapper is sprayed (22), on the upper face thereof, with an aqueous solution (24) for activating its adhesive (FIG. 6A). The free end (9) of the wrapper (1) is bound an outer peripheral portion of the master roll (10) and the master roll (10) is wrapped with at least one coil of wrapper (1) such that a length of wrapper (8) overlaps the bound free end (9) (FIG. 6B). The overlapping length of wrapper (8) is then bound to an outer surface of the wrapper (1) previously coiled on the master roll (10) (FIGS. 6C to 6E). Preferably, the overlapping length (8) is sprayed (22), on the upper face thereof, with an aqueous solution (24) for activating its adhesive (FIG. 6C). The length of wrapper (8) is then bound to an outer surface of the wrapper (1) previously coiled on the master roll (10) (FIGS. 6D to 6E). Rolling the master roll (10) on two rolls (40) provides a sufficient pressure for bounding solidly the activated adhesive of the wrapper (1). The wrapper (1) is cut (30) to separate the wrapped roll (50) from the roll (20) of wrapper (1) (FIGS. 6E and 6F). The final product obtained is a wrapped master roll (50) (FIG. 6F).

The wrapped master roll of the invention may be a roll of newsprint, roll of coated paper, a roll of fine paper, a roll of carbon-less paper, and a roll of specialty paper. Such rolls typically have a diameter of about 1 foot (30 cm) to about 7 feet (210 cm) and a width of 1 foot (30 cm) to about 12 feet (360 cm).

As it will now be demonstrated by way of some examples hereinafter, the wrappers according to the invention have many advantages.

### EXAMPLES

The following examples are illustrative of the wide range of applicability of the present invention and are not intended to limit its scope. Modifications and variations can be made therein without departing from the spirit and scope of the invention. Although any methods and materials similar or equivalent to those described herein can be used in the practice for the testing of the present invention, the preferred methods and materials are described.

### Example 1

### Single Layer Wrappers and Cardboard

Different types of wrappers were prepared using a laboratory coating device equipped with mayer rods of different sizes. Table 1 below shows different samples which have been prepared by coating different types of water-activatable adhesives directly onto plain Kraft paper substrates using a pilot plant coating device. Using this device, known quantities of water-activatable adhesive were applied to a paper surface and were dried at 100° C. for 2 min.

Sample 1 represents a typical example of a ream wrap, Samples 2 and 4 are typical examples of a wrapper for wrapping a master roll, and Sample 3 is a ample of a cardboard useful for manufacturing a box suitable for dry the like.

TABLE 1

| | Weigh of the | Water-activatable | Weigh of the |
|---|---|---|---|
| Sample | sheet of paper | adhesive | adhesive |
| 1 | 75 g/m² | ENVA-L0K ™ 684074 | 5 g/m² |
| 2 | 337 g/m² | NACAN ™ 682372 | 10 g/m² |
| 3 | 205 g/m² | VINAVYL ™ 2419 | 15 g/m² |
| 4 | 269 g/m² | VINAVYL ™ 2431 | 40 g/m² |

Reycling abilities of samples 1 to 4 were assessed by repulping sample 4, the sample onto which the highest amount of adhesive was applied. This assessment was made using conventional methods. Briefly, the sample was placed in a TAPPI disintegrator pulping system for 18 minutes at 23° C. and 2.5% of consistency. During repulping, the water-activatable adhesive dissociated from the paperboard fibers and was reduced into finer particles or partially dissolved into the water. Laboratory paperboard hand sheets were then produced according to the TAPPI 205 method-forming hand sheets for physical testing of the pulp. Each hand sheet weight 1.2 g and was air dried on couch plates in retaining rings with no wet pressing. According to industrial standards, an adhesive is said to be repulpable if it separates from the cellulosic fibers and if the hand sheet does not contain large pieces of coating higher than 1/16 square inch (about 1.6 square mm). Sample 4 showed an excellent repulpability with particles of adhesive having a size much smaller than 1/16 square inch (about 1.6 square mm). A very good separation of the water-sensitive adhesive from the wood fibers was also achieved. Similar and even better results were also obtained with samples 1 to 3.

The bounding properties of the four samples were also tested. The roll wrapper samples were activated by spraying water onto the surface of the water-activatable adhesives and the wrappers were wrapped around a newsprint roll with a diameter of 10-inch (about 25.4 cm). The wrapped rolls were conditioned under different relative humidity (from 50% to 90%), at different temperatures (from −50° C. to 37° C.) and for different periods of time (from 1 to 5 days). After the conditioning period, the newsprint rolls were unwrapped and adhesion bonding was evaluated by measuring: 1) the amount of newsprint fibers remaining attached onto the wrapper surface, 2) the amount of wood fibers extracted from the outside Kraft linerboard surface, and 3) the amount of fibers that remained attached onto the water-activated adhesive surface. These amounts were then converted into percentage values. Table 2 hereinbelow presents the results obtained under conditions of 90% humidity, at 37° C. for a period of 5 days.

TABLE 2

| | Adhesion to the | Adhesion to the outside |
|---|---|---|
| Sample | newsprint roll | Kraft linerboard surface |
| 1 | 75% | 55% |
| 2 | 85% | 60% |
| 3 | 90% | 80% |
| 4 | 100% | 95% |

### Example 2

### Wrapper with a Functional Barrier

A roll wrapper with a water vapor barrier was prepared. Briefly, a Kraft paperboard of 269 g/m² was coated with 30 g/m² of VAPOR COAT 120™ (Michelman, Cincinatti) (the water vapor barrier) using a rod coater process. Then, 20 g/m² of ENVA-LOK™ 684074 (the adhesive) was coated over the water vapor barrier. Water vapor transmission characteristics of the final product were measured according to the standard TAPPI 464 method. The water vapor transmission value was found to be 35 g of water/m²/day. This roll wrapper was water activated by a steam jet and wrapped around a 10-inch (about 25.4 cm) newsprint roll and after being conditioned (90% humidity, 37° C., 5 days), the wrapper was unwrapped and its bounding properties were measured. Adhesion to the newsprint roll was found to be 100% and adhesion to the outside ply of the Kraft wrapper was 95%. Similar satisfying results were also obtained with newsprint roll having a 25-inch diameter (about 63.5 cm) and a width of 40 inches (about 103.6 cm).

### Example 3

### Multi-Layer Laminated Paperboard Construction

A multi-layer laminated paperboard construction was prepared. A 30 g/m² water vapor barrier (VAPOR COAT 120™) was laminated between two 126 g/m² linerboard plies using a two rods coating station process. Briefly, the vapor barrier was added at first coating station of a two rods coater apparatus. The second coating station of the apparatus was then used to apply a 25 g/m² coating of a water-sensitive adhesive (NACAN™ 682372) on the external surface of one of the linerboards. After being activated by water with a roll applicator, this laminated paperboard construction was glued onto a 10-inch (about 25.4 cm) diameter newsprint roll. Adhesion to the newsprint roll was found to be 100% and adhesion to the outside ply of the paperboard construction was 95%. Similar satisfying results were also obtained with newsprint roll having a 25-inch diameter (about 63.5 cm) and a width of 40 inches (about 103.6 cm).

### Example 4

### Blocking Resistance of the Wrapper

It is recognized that regular wrappers coated with water based glues are sensitive to developing roll blocking that is generally caused by pressure, high relative humidity and/or high temperature. As it will be demonstrated hereinbelow, another advantage of the wrapper of the present invention is that the use of water-activatable adhesive increases the resistance of the wrapper to roll blocking.

Effect of Relative Humidity

A multi-layer laminated roll of wrapper was prepared as described in Example 3. This roll was conditioned under a relative humidity varying from 35 to 90% and at different temperatures (from 10° C. to 45° C.) for a period of 50 days. The roll of wrapper was rewound after this conditioning period. Interestingly, no blocking was observed from the beginning of the roll to the end.

Effect of Pressure

A common problem with regular wrappers is that some blocking appears during transportation of the rolls of wrapper. This blocking is mainly due to roll clamping or tension inside the roll.

A multi-layer laminated roll of wrapper was prepared as described in Example 3. Many 5.5 square inch (about 14 square cm) samples of wrapper were stacked with each sample having its water-activatable adhesive side in contact with the cellulosic side of another sample. A 10 kg weight was then deposited above the stacked samples of wrapper and, after two weeks, blocking was evaluated. Interestingly, no pressure sensitive blocking was observed.

Effect of Temperature

A multi-layer laminated roll of wrapper was prepared as described in Example 3. This roll was tested for heat sensitive blocking according to a standard heat sealing testing method. Briefly, heat sealing was processed at 200° C., 40 psi (about 275.8 kPa) for 5 seconds. Interestingly, no heat sensitive blocking was observed.

While several embodiments of the invention have been described, it will be understood that the present invention is capable of further modifications, and this application is intended to cover any variations, uses, or adaptations of the invention falling within the scope of the claims. Although the main anticipated use of the water-based adhesive described hereinbefore is for the manufacture of cellulosic wrappers and cardboard containers, the person skilled in the art will understand that the invention is capable of many modifications and that it can be used in many other related industries. For instance, the wrappers of the invention could be used to manufacture honeycomb-like pad that could be sticked (once the adhesive activated with water) into a cardboard box for protecting products to be shipped.

What is claims is:

1. A method for wrapping a master roll of paper, the method comprising the steps of:
providing a wrapper comprising a sheet of a cellulosic material having a first face opposite to a second face, the first face having an area coated with a water-activatable adhesive;
wrapping the master roll of paper with a length of said wrapper sufficient to allow said area of the first face to face the second face;
activating said water-activatable adhesive coating said area of the first face; and
applying on said area a pressure sufficient to bound said area of the first face to the second face.

2. The method of claim 1, wherein said water-activatable adhesive is activated at the end of the wrapping before the first face faces the second face.

3. The method of claim 1, wherein said water-activatable adhesive is activated by applying an aqueous solution on said area of the first face.

4. The method of claim 3, wherein the step of applying the aqueous solution consists of spraying said aqueous solution.

5. The method of claim 3, wherein the step of applying the aqueous solution consists of vaporizing said aqueous solution.

6. The method of claim 3, wherein said aqueous solution consists of water.

7. The method of claim 1, wherein said pressure is applied by rolling the master roll of paper on a roll.

8. The method of claim 1 comprising, before the step of wrapping, a preliminary step of bounding a free end of the wrapper to an outer peripheral surface of the master roll.

9. The method of claim 8, wherein the free end comprises an area coated with a water-activatable adhesive, and wherein the step of bounding the free end comprises the steps of: i) activating the water-activated adhesive of the free end, and ii) applying a pressure on said free end to achieve said bonding.

10. The method of claim 1, wherein the first face is fully coated with the water-activatable adhesive.

11. The method of claim 1, wherein said sheet of cellulosic material is made of a material selected from the group consisting of virgin wood fibers, recycled wood fibers, cotton fibers and mixtures thereof.

12. The method of claim 1, wherein said sheet of cellulosic material has a weigh between about 10 g/m² to about 350 g/m².

13. The method of claim 1, wherein said sheet of cellulosic material has a thickness between about 100 μm to about 500 μm.

14. The method of claim 1, wherein said water-activatable adhesive is selected from the group consisting of: dextrin-based adhesives, vinyl/acrylic copolymer emulsions and acrylic emulsion polymers.

15. The method of claim 1, wherein said water-activatable adhesive has a dried weight of about I g/m² to about 70 g/m².

16. The method of claim 1, wherein said wrapper is a laminated, multi-layered product further comprising a functional barrier between the cellulosic sheet and the water-activatable adhesive.

17. The method of claim 16, wherein the functional barrier is selected from the group consisting of polyolefines, polyesters and latexes.

18. A method for wrapping a master roll of paper manufactured in a paper-maker plant, the method comprising the steps of:
a) providing a roll of wrapper having a free end, the wrapper comprising a sheet of a cellulosic material having a first face opposite to a second face, the first face being coated with a water-activatable adhesive;
b) spraying said free end of the wrapper, on the first face thereof, with an aqueous solution for activating the adhesive therein;
c) bounding the free end of the wrapper to an outer peripheral portion of the master roll;
d) wrapping the master roll with at least one coil of wrapper such that a length of wrapper overlaps the free end bound at step (c);
e) spraying said length of wrapper, on the first face thereof, with an aqueous solution for activating the adhesive therein; and
f) bounding the length of wrapper sprayed at step (e) to an outer surface of the wrapper previously coiled in step (d) on the master roll.

19. A wrapped master roll of paper manufactured in a paper-maker plant, comprising a master roll of paper having an outer peripheral surface wrapped with at least one coil of wrapper, the wrapper comprising a sheet of a cellulosic material having an area coated with a water-activated adhesive.

20. The wrapped master roll of claim 19, wherein said wrapper comprises overlapping surfaces bound together with said water-activated adhesive.

21. The wrapped master roll of claim 19, wherein said wrapper comprises an end coated with a water-activated adhesive and wherein said coated end is bound to the outer peripheral surface of master roll.

22. The wrapped master roll of claim 19, wherein the master roll is selected from the group consisting of roll of a newsprint, a roll of coated paper, a roll of fine paper, a roll of carbon-less paper, and a roll of specialty paper.

23. The wrapped master roll of claim 19, wherein the master roll has a diameter of about 1 foot to about 7 feet.

24. The wrapped master roll of claim 19, wherein the master roll is wrapped with a wrapper further comprising a functional barrier between the cellulosic sheet and the water-activated adhesive.
